(19) United States
(12) Patent Application Publication
(10) Pub. No.: US 2014/0214697 A1
(43) Pub. Date: Jul. 31, 2014

(54) REFUSE COLLECTION SYSTEM AND METHOD

(71) Applicant: Paul Terence McSweeney, Dublin (IE)

(72) Inventor: Paul Terence McSweeney, Dublin (IE)

(21) Appl. No.: 14/123,428

(22) PCT Filed: Jun. 1, 2012
(86) PCT No.: PCT/EP2012/060452

§ 371 Date: Mar. 6, 2014

(30) Foreign Application Priority Data
Jun. 3, 2011 (GB) 1109363.0

(51) Int. Cl. G06Q 10/00

(52) U.S. Cl. CPC G06Q 10/30
USPC 705/308

(57) ABSTRACT

This invention relates to a refuse collection system and method in which there are provided a plurality of households, each having their own refuse bin, a control centre computer in communication with each of the refuse bins, and a plurality of collection vehicles in communication with the control centre computer. An RFID tag with information regarding the type of refuse is associated with refuse prior to the refuse being placed in the refuse bin. Preferably, the refuse is placed in a dedicated pod with an RFID attached thereto. The bin has an RFID reader that reads the RFID tag, determines what types of refuse are contained within the bin and thereafter transmits the information to the control centre computer. The control centre computer thereafter schedules the delivery of one or more types of refuse from the refuse bins and transmits a collection itinerary to a collection vehicle. Advantageously, third party logistics providers may utilize their backhaul capacity and operate as collection vehicles if desired.

This invention relates to a refuse collection system and method.

In many developed countries, domestic waste is placed in refuse bins by homeowners. The refuse bins are periodically emptied into large waste disposal trucks by refuse disposal operators so that the waste can be brought to a landfill site, an incinerator or a waste treatment centre. In some countries, a degree of pre-sorting of the waste by the homeowners is encouraged. In those cases, a separate refuse bin is usually provided for the recyclable waste such as glass, paper, certain types of plastics and other recyclable materials to keep them separate from the other general waste. A separate waste disposal truck collects the refuse bins with the recyclable materials and brings those recyclable materials to a recycling plant where the materials are sorted and recovered.

Similar systems are also in place for commercial waste. It will be understood that the present invention is not limited to refuse collection systems and methods for handling domestic waste but rather also relates to refuse collection systems and methods for handling commercial waste and or industrial waste. However, for reasons of brevity and simplicity, the invention will hereinafter be described with reference to refuse collection systems and methods for handling domestic waste only but will be understood to equally apply to handling commercial waste.

Pre-sorting of waste is highly desirable for a number of reasons. First of all, less material is sent to landfill or sent for incineration and more materials are recovered for subsequent reuse from the waste material. Secondly, the customer can reduce their refuse collection charges as the recyclable waste is usually collected for free or at a significantly lower cost than other refuse. Thirdly, the refuse disposal operator can reduce their costs as they do not have to carry out the same degree of sorting of the refuse at their facility and can reduce the cost of landfill to them.

However, there are problems with the existing methods and systems for handling waste. In particular, the pre-sorting currently in operation is still relatively primitive and the task of sorting the recyclable waste at a waste treatment centre is still relatively onerous and requires significant infrastructure. It would be advantageous if the waste could be pre-sorted in a more effective manner. Secondly, the current methods and systems provide for periodic, typically weekly or fortnightly collections of the refuse bins regardless of whether or not the refuse bins need to be collected. It would be preferable if the refuse bins or indeed certain items from the refuse bins were collected only when those items were present in the refuse bin and or when the refuse bin required emptying.

In addition to the above, there is a further problem in that there is a considerable burden on the refuse disposal operators to frequently collect waste from the households. This requires a significant amount of infrastructure, personnel and organisation. This structure is expensive to provide and maintain and it would be advantageous if alternative solutions could be provided to lighten the burden on the refuse disposal operators.

It is an object of the present invention to provide a refuse collection system and method that overcomes at least some of the problems with the known systems and methods. It is a further object of the present invention to provide a refuse handling methodology that will provide more effective recycling of refuse materials.

### STATEMENTS OF INVENTION

According to the invention there is provided a refuse collection system for a plurality of households, each household having its own dedicated refuse bin located at that household, the refuse collection system comprising the plurality of refuse bins located at the households, a control centre computer operated by a refuse disposal operator in communication with each of the bins in each of the households, and a plurality of collection vehicles also in communication with the control centre computer, in which:

the refuse bins in each of the households each comprise:
an RFID reader unit and a communications module; the RFID reader unit being configured to recognize refuse having an RFID tag associated therewith located in the bin and generate a data message indicative of the type and quantity of refuse in the refuse bin; the communications module being configured to receive the data message from the RFID reader unit and thereafter transmit the data message to the control centre computer operated by the refuse disposal operator;

the collection vehicles each having:
a GPS tracking unit associated therewith and a communications module for communications with the control centre computer, the collection vehicles each being configured to periodically transmit their location data to the control centre computer;

the control centre computer having:
a communications module configured to receive data messages transmitted by the communications modules in each of the refuse bins; the control centre computer having a scheduling module stored thereon for scheduling a refuse collection of a particular type of refuse from at least one of the refuse bins in it least one of the households based on the data message received from the communications module of the refuse bin, the scheduling module being configured to generate a collection itinerary for a collection vehicle based on the location data received from the collection vehicle and the data messages received from the refuse bins, the control centre computer being configured to transmit the collection itinerary to the collection vehicle.

By having such a system, the refuse disposal operator will know precisely what refuse is in the refuse bins of each individual household. The refuse bins of each household have an RFID reader that will read the RFID tags of the refuse in the bin and determine what refuse is contained in the refuse bin and how much of that refuse is contained in the refuse bin. Once the RFID reader has this information, it will create a data message which will be transmitted to the control centre computer of the refuse disposal operator. The refuse disposal operator will thereafter be able to organise the collection of refuse in a very efficient manner that was heretofore not possible. Furthermore, by knowing the location data of the collection vehicles, the control centre computer can determine which vehicles should be used to collect what goods and determine the most appropriate route for those vehicles to take to collect a number of goods from the households.

For example, if it is desired to collect batteries for recycling, a refuse collection van may be sent out with a list including the location of all the refuse bins that contain batteries for recycling. The refuse collection van can travel around collecting the batteries out of the refuse bins on the list and leave the remaining refuse in the refuse bins for subsequent collection if desired. Alternatively, the remaining refuse may also be collected but special emphasis will be placed on collecting those refuse bins containing batteries. If desired, only those refuse bins with a given amount of the required refuse will be collected. Once the refuse has been collected, it may be delivered directly to a dedicated recycling plant that specialises in handling that particular type of waste and this will help reduce the space required at the refuse disposal operator's facility.

In one embodiment of the invention there is provided a refuse collection system in which the interior of one or more of the refuse bins is divided into a plurality of compartments, each for reception of refuse having an RFID tag associated therewith. This is seen as a particularly useful embodiment of the present invention. By having such a refuse bin as part of the system, the individual items will be able to be retrieved far quicker from the refuse bin than might otherwise be the case if all items were placed one on top of the other in a haphazard manner in the refuse bin.

In one embodiment of the invention there is provided a refuse collection system in which the interior of one or more of the refuse bins is divided into a plurality of compartments, one of which is for reception of a non-refuse good having an RFID tag associated therewith. This is also seen as particularly useful as the refuse bins can also be used to store non-refuse items that may be collected from the household. For example, a parcel for delivery to a third party may be placed in the refuse bin and this parcel can be collected by an appropriate party that has been notified of the parcels whereabouts by the control centre computer.

In one embodiment of the invention there is provided a refuse collection system in which the control centre computer is provided with means to receive a goods collection request from a household resident through an alternative communications channel other than through a data message sent by one of the refuse bins, and in which the scheduling module is configured to generate a collection itinerary for a collection vehicle based on the location data received from the collection vehicle and the goods collection request received from the household resident through the alternative communications channel, the control centre computer being configured to transmit the collection itinerary to the collection vehicle. It is envisaged that the goods collection request may be made through a web-based interface, a mobile phone app that may include a scanner for scanning in, for example, a bar code or a QR code, with information relating to the good, a mobile telephone equipped with an RFID scanner or indeed an SMS message transmitted directly from a system users mobile telephone.

In one embodiment of the invention there is provided a refuse collection system in which the refuse bin's communications module comprises a short messaging service (SMS) module for generating and transmitting the data message in an SMS message to the control centre computer.

In one embodiment of the invention there is provided a refuse collection system in which the refuse bin's communications module comprises a radio transmitter for transmitting the data message to the control centre computer.

In one embodiment of the invention there is provided a refuse collection system in which the refuse bin's communications module comprises a node of a WPAN and in which there is further provided a control unit of the WPAN located remotely from the node of the WPAN and in communication with the refuse bin's communications module for receipt of data messages from the refuse bin's communications module, the control unit of the WPAN having means to transmit the data message onwards to the control centre computer.

In one embodiment of the invention there is provided a refuse collection system in which each of the refuse bins is further provided with means to detect the available capacity of the refuse bin, said means being in communication with the refuse bin's communications module. This is seen as a particularly useful aspect of the present invention as the refuse bin will be able to notify the control centre computer if it is full or nearly full and requires emptying. If the refuse bin signals that it is nearly full, the refuse disposal operator can arrange a collection of the refuse bin's contents even if they are not perhaps the ones that are required at that moment in time.

In one embodiment of the invention there is provided a refuse collection system in which one or more of the collection vehicles are operated by a third party logistics provider. This is seen as a particularly preferred aspect of the present invention. The third party logistics provider can collect refuse or other items from the households on demand. This will enable the third party logistics operator to make more efficient use of its backhaul capacity and will reduce the burden on the refuse disposal operator. It is envisaged that as the refuse and other goods for collection will be relatively clean, third party logistics operators will be willing to utilize their backhaul capacity to transport these goods or refuse.

In one embodiment of the invention there is provided a method of scheduling the collection of refuse by a refuse disposal operator from a plurality of households, each household having its own dedicated refuse bin located at that household, in a refuse collection system comprising the plurality of refuse bins located at the households, a control centre computer operated by the refuse disposal operator in communication with each of the bins in each of the households, and a plurality of collection vehicles also in communication with the control centre computer, the refuse bins in each of the households each comprise an RFID reader unit and a communications module; the collection vehicles each having a GPS tracking unit associated therewith and a communications module for communications with the control centre computer; the control centre computer having a communications module configured to receive data messages transmitted by the communications modules in each of the refuse bins and the control centre computer having a scheduling module stored thereon, the method comprising the steps of:
in each of the refuse bins, the RFID reader unit detecting refuse having an RFID tag associated therewith located in the refuse bin and generating a data message indicative of the type and quantity of refuse in the refuse bin; the refuse bins communication module receiving the data message from the bin's RFID reader unit and thereafter transmitting the data message to the control centre computer operated by the refuse disposal operator; and
the collection vehicles each periodically transmitting their location data to the control centre computer; and
the control centre computer receiving the plurality of data messages from the refuse bins, the control centre computer collating the data messages and determining the types of refuse available for collection and the amount of each type of refuse available for collection, the control centre computer's scheduling module scheduling a refuse collection of a particular type of refuse from at least one of the refuse bins in it least one of the households based on the collated data messages received from the communications modules of the refuse bins; the scheduling module generating a collection itinerary for a collection vehicle based on the location data received from the collection vehicle and the collated data messages received from the refuse bins; and the control centre computer transmitting the collection itinerary to the collection vehicle.

This is seen as a particularly useful way of scheduling the collection of waste. In this way, the refuse disposal operator can collect a particular type of refuse from their customers without having to collect several other types of refuse from their customer's refuse bins which was heretofore not possible. The method will allow the refuse disposal operator to have specialized refuse collection vans dedicated to the collection of particular items and those refuse collection vans can travel to the refuse bins where they know there will be refuse of their required type.

In one embodiment of the invention there is provided a method comprising the additional steps of: the control centre computer receiving a non-refuse goods collection request; the scheduling module generating a collection itinerary for a collection vehicle based on the location data received from the collection vehicle and the non-refuse goods collection request; and the control centre computer transmitting the collection itinerary to the collection vehicle. This is seen as a particularly preferred embodiment of the present invention. In this way, the refuse collection method can be used for the collection and subsequent delivery of non-refuse items as well. These non-refuse items may be collected by a third party logistics provider and transported to their depot or another parties depot for subsequent processing or onwards delivery to a third party.

In one embodiment of the invention there is provided a method in which the control centre computer receives the non-refuse goods collection request through an alternative communications channel other than through a data message sent by one of the refuse bins.

In one embodiment of the invention there is provided a method in which having scheduled the collection of one of refuse and a good, a message is transmitted by the control centre computer to the owner of the refuse bin from which a collection will be made indicating that a collection is imminent. In this way, it will be possible to prompt the owner of the refuse bin to leave the refuse bin in an accessible location so that the refuse disposal operator can collect from the refuse bin.

In one embodiment of the invention there is provided a method in which the step of transmitting a collection itinerary to the collection vehicle further comprises transmitting the collection itinerary to a collection vehicle operated by a third party logistics provider.

In one embodiment of the invention the method comprises providing a method for the disposal and collection of refuse from a plurality of households, each household having its own dedicated refuse bin located at that household, in a refuse collection system comprising the plurality of refuse bins located at the households, a control centre computer operated by a refuse disposal operator, and a plurality of collection vehicles, the refuse bins in each of the households each comprise an RFID reader unit and a communications module for transmitting data messages to the control centre computer; the collection vehicles each having a GPS tracking unit associated therewith and a communications module for communications with the control centre computer; the control centre computer having a communications module configured to communicate with the collection vehicles and to receive data messages transmitted by the communications modules in each of the refuse bins and the control centre computer having a scheduling module stored thereon, the method comprising the steps of:
the residents associating an RFID tag with an item of refuse prior to placing the refuse in the refuse bin, the RFID tag having a code indicative of the type of refuse to which it is being associated;
the refuse bin RFID reader reading the RFID tag associated with an item of refuse in the bin and generating a data message detailing the contents of the refuse bin;
the RFID reader passing the data message to the communications module of the refuse bin and the communications module transmitting the data message onwards to the control centre computer;
the control centre computer receiving a plurality of data messages from the plurality of refuse bins;
the control centre computer collating the data messages and determining the types of refuse available for collection and the amount of each type of refuse available for collection;
the control centre computer receiving location data from each of the collection vehicles; and
the control centre computer scheduling module generating a collection itinerary for a collection vehicle based on the location data received from the collection vehicle and the collated data messages received from the refuse bins;
the control centre computer transmitting the collection itinerary to the collection vehicle; and
the collection vehicles collecting the refuse from the refuse bins.

This is seen as a particularly useful method of disposing of and organising collection of refuse from customers. The customer is very much involved in the process and they will pre-sort the refuse to a very granular level which will greatly facilitate the subsequent collection and handling of the refuse. The customers associate an RFID tag with the refuse and this will enable the refuse bin's RFID reader to subsequently determine the content of the bin and transmit that information in a data message to the control centre computer of the refuse disposal operator. The refuse disposal operator can in turn organise their collections in a highly efficient manner so that they can collect specified items of refuse from their customers refuse bins.

In one embodiment of the invention there is provided a method in which the step of scheduling the collection of a particular type of refuse comprises the steps of:
providing a refuse collection vehicle to collect that particular type of refuse;
providing a collection itinerary to the refuse collection vehicle specifying the location of each of the refuse bins from which it is due to collect; and
the refuse collection vehicle travelling to the locations of the refuse bins and collecting the specified type of refuse from the refuse bins.

In one embodiment of the invention there is provided a method in which the refuse collection vehicle delivers the collected refuse to a specified recycling centre that is dedicated to recycling that particular type of refuse.

In one embodiment of the invention there is provided a method in which the control centre computer schedules collection of two or more disparate types of refuse from a plurality of the refuse bins based on the collated data.

In one embodiment of the invention there is provided a method in which the step of the residents associating an RFID tag with an item of refuse prior to placing the refuse in the refuse bin further comprises the residents placing the refuse in a pod having the RFID tag. This is seen as a particularly preferred embodiment of the present invention. The pod may be constructed from a paper, cardboard or plastics material or indeed a combination of two or more of these materials, and it is envisaged that the pod may be a rigid or semi-rigid container or a paper or plastics flexible envelope or pouch that can safely and securely hold the items for recycling. For example, the items for recycling may be razor blades and these can be placed in a cardboard pod before being placed in the refuse bin. The items will stay together in the refuse bin and can be collected and handled safely with ease.

In one embodiment of the invention there is provided a method in which the step of the residents associating an RFID tag with an item of refuse prior to placing the refuse in the refuse bin further comprises the residents applying the RFID tag directly to the refuse. It is envisaged that the customer may be supplied with a number of RFID tags, each having an adhesive backing or other means to secure the RFID tag to the refuse. The RFID tags with the adhesive backing can be stuck onto the refuse before the refuse is placed into the refuse bin. Such tags are sometimes referred to as ‘slap and ship’ tags. This will help to reduce the amount of packaging required and may be used instead of or in conjunction with the pods.

In one embodiment of the invention the method comprises the initial step of the residents programming the RFID tag with the code indicative of the type of refuse to which it is being associated. This is also seen as a useful alternative embodiment of the present invention. The RFID tags may be non-specific until a code is programmed into the RFID tag by the customer. In this way, the customer can simply program the code into the RFID tag before applying the RFID tag to the refuse or placing the refuse into the pod with the RFID tag. This will provide greater flexibility for the customer.

In one embodiment of the invention there is provided a method comprising the additional steps of: the refuse bin further comprising a means to detect the available capacity of the refuse bin, said means being in communication with the communications module; the means to detect the available capacity of the refuse bin passing a data message indicating the available capacity in the refuse bin to the communications module and the communications module transmitting the data message onwards to the control centre computer; and the control centre computer scheduling the collection of a refuse bin based on the available capacity in the refuse bin.

In one embodiment of the invention there is provided a method in which the refuse bin is provided with a plurality of compartments each of which is dedicated to a particular type of refuse and in which the step of the resident placing the refuse in the refuse bin further comprises the resident placing the refuse in an appropriate compartment of the refuse bin.

In one embodiment of the invention there is provided a method in which the method comprises the additional steps of: a resident associating the RFID tag with a non-refuse good item prior to placing the item in the refuse bin; transmitting a non-refuse good collection request to the control centre computer; the control centre computer receiving a non-refuse goods collection request; the scheduling module generating a collection itinerary for a collection vehicle based on the location data received from the collection vehicle and the non-refuse goods collection request; and the control centre computer transmitting the collection itinerary for the non-refuse good to the collection vehicle.

In one embodiment of the invention there is provided a method in which the control centre computer receives the non-refuse goods collection request through an alternative communications channel other than through a data message sent by one of the refuse bins.

In one embodiment of the invention there is provided a method in which the step of transmitting the collection itinerary comprises transmitting the collection itinerary to a third party logistics provider.

In one embodiment of the invention there is provided a method of scheduling the collection of one or more goods from a plurality of households and thereafter distributing the goods to one or more recipients, in a system comprising a control centre computer having a scheduling module and a control centre computer communications module, a plurality of households each having a communications module associated therewith for communication with the control centre computer communications module, and a plurality of collection vehicles operated by a plurality of third party logistics operators, each collection vehicle having a GPS tracking unit and a collection vehicle communications module for communication with the control centre computer communications module, the method comprising the steps of:
an individual associated with a particular household transmitting a good collection request to the control centre computer;
the control centre computer collating that good collection request with good collection requests for the same type of goods received from a plurality of other individuals associated with other households;
the control centre computer's scheduling module generating a collection itinerary for one of the collection vehicles based on location data received from the collection vehicle and the plurality of good collection requests;
the control centre computer transmitting the collection itinerary to one of the collection vehicles; and
the collection vehicle thereafter following the collection itinerary and collecting the good from the household and delivering the good to a desired recipient.

By having such a method, the collection of goods, including but not limited to refuse, from a household can be scheduled in a very simple manner and the goods can be collected and delivered onwards to an intended recipient in a fast and efficient manner. According to this embodiment of the present invention, it is not necessary to provide a bin having an RFID reader in order to inform the refuse disposal operator or other interested party that there is a good or refuse to collect, although that remains one manner in which the refuse disposal operator or other third party may be alerted. Instead, an individual associated with the household can contact the control centre computer using other means, such as, but not limited to their mobile telephone or a computing device having access to the internet or web, that there is a good for collection at the household and the collection can thereafter be made. Furthermore, as there are a plurality of third party logistics operators providing the collection vehicles, an appropriate choice of vehicle can be made depending on the type of good or refuse to be collected and the backhaul capacity of the third party logistics operators can be utilized more efficiently.

In one embodiment of the invention there is provided a method comprising the additional step of the individual packaging the good in a dedicated pod with an identifier of the goods associated therewith prior to the goods collection. This is seen as a particularly preferred embodiment of the present invention as the goods can be transported in their dedicated pods but can also be stored outdoors if desired providing a degree of protection to the goods/refuse from the elements while the goods/refuse are awaiting collection.

In one embodiment of the invention there is provided a method comprising the initial step of the individual registering their household with the control centre computer by providing at least their address and their contact details to the control centre computer.

In one embodiment of the invention there is provided a method in which the step of transmitting the collection itinerary to one of the collection vehicles comprises transmitting the collection itinerary to one of the collection vehicles in response to a collection itinerary request issued by the collection vehicle. In this way, if a third party logistics operator should finish all of their deliveries early, it can make itself available to the method for the collection and delivery of goods or refuse thereby making more efficient use of third party logistics operator's backhaul capacity.

In one embodiment of the invention there is provided a method in which the collection itinerary request includes the time duration that the collection vehicle is available to collect and distribute goods and the collection itinerary is compiled taking into account the available time duration. By providing such a method, it will be possible to provide an itinerary that may be completed in the available time by the third party logistics operator's collection vehicle. It is envisaged that the third party logistics operator will only have a short time period in which it is available towards the end of a shift in which it can collect and deliver goods or refuse and this is taken into account by the collection vehicle indicating the time that is available to them.

### DETAILED DESCRIPTION OF THE INVENTION

The invention will now be more clearly understood from the following description of some embodiments thereof given by way of example only with reference to the accompanying drawings, in which:—

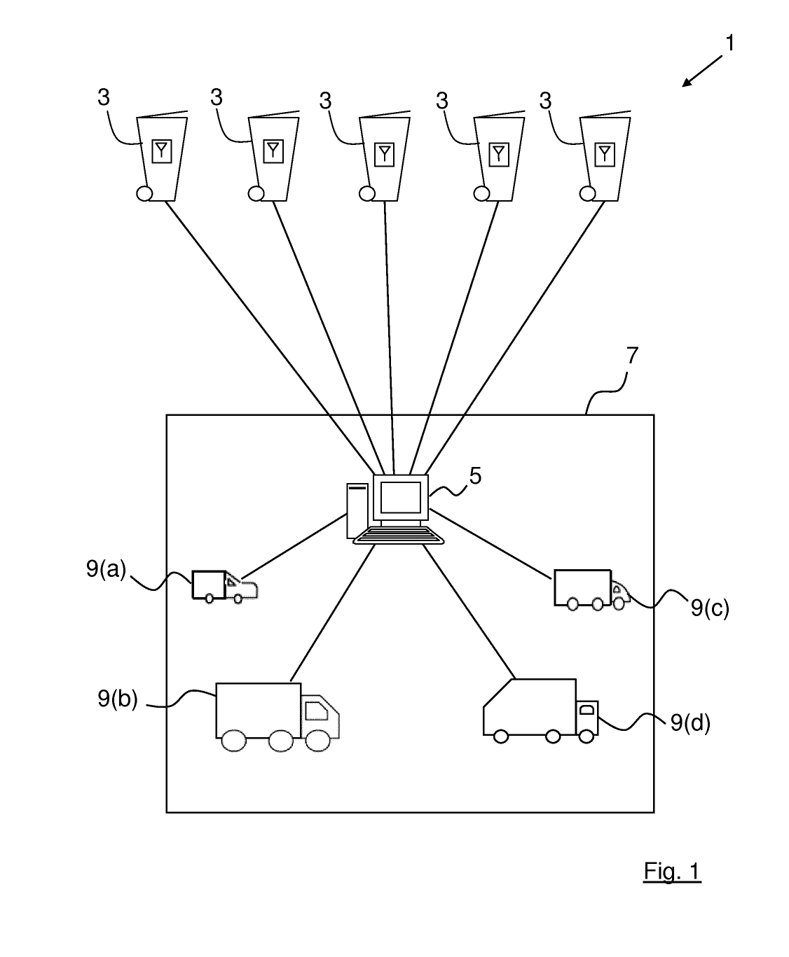

FIG. 1 is a diagrammatic representation of a system for refuse disposal and collection according to the present invention;

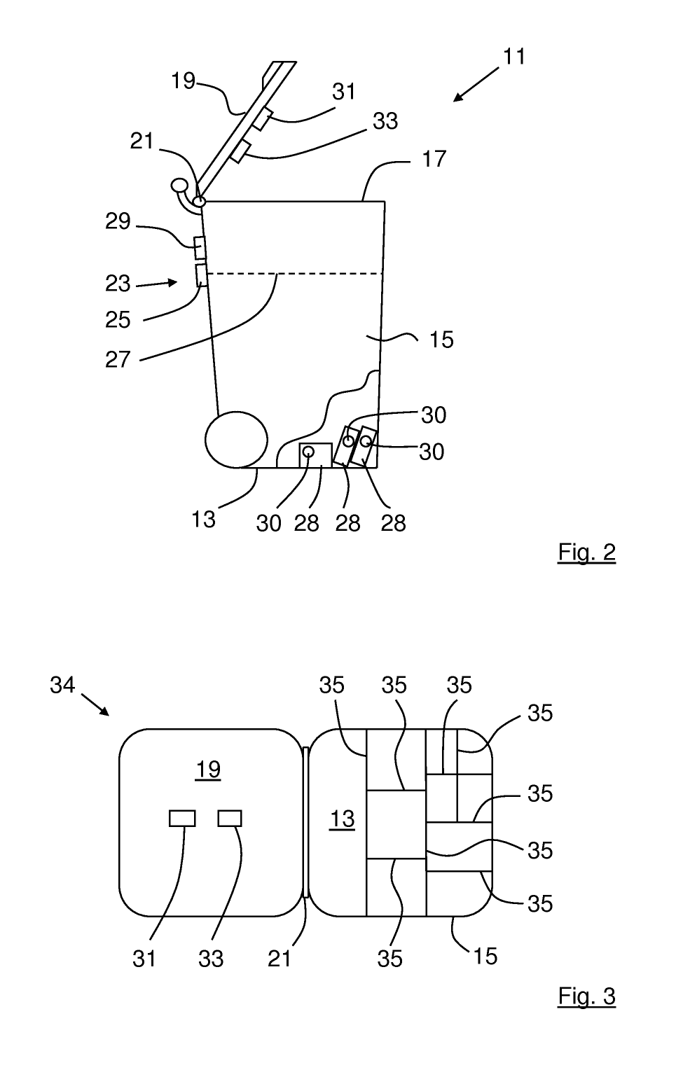

FIG. 2 is a diagrammatic representation of a refuse bin for use in the method and system according to the invention;

FIG. 3 is plan view of an alternative embodiment of a refuse bin according to the present invention;

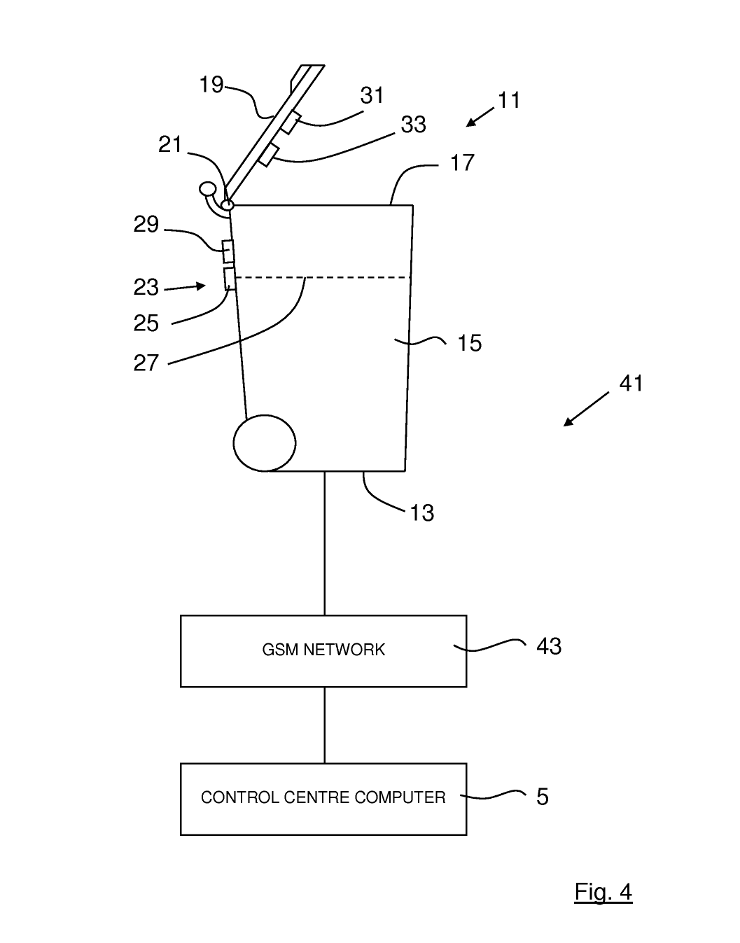

FIG. 4 is a diagrammatic representation of one embodiment of system in which the method according to the invention may be implemented;

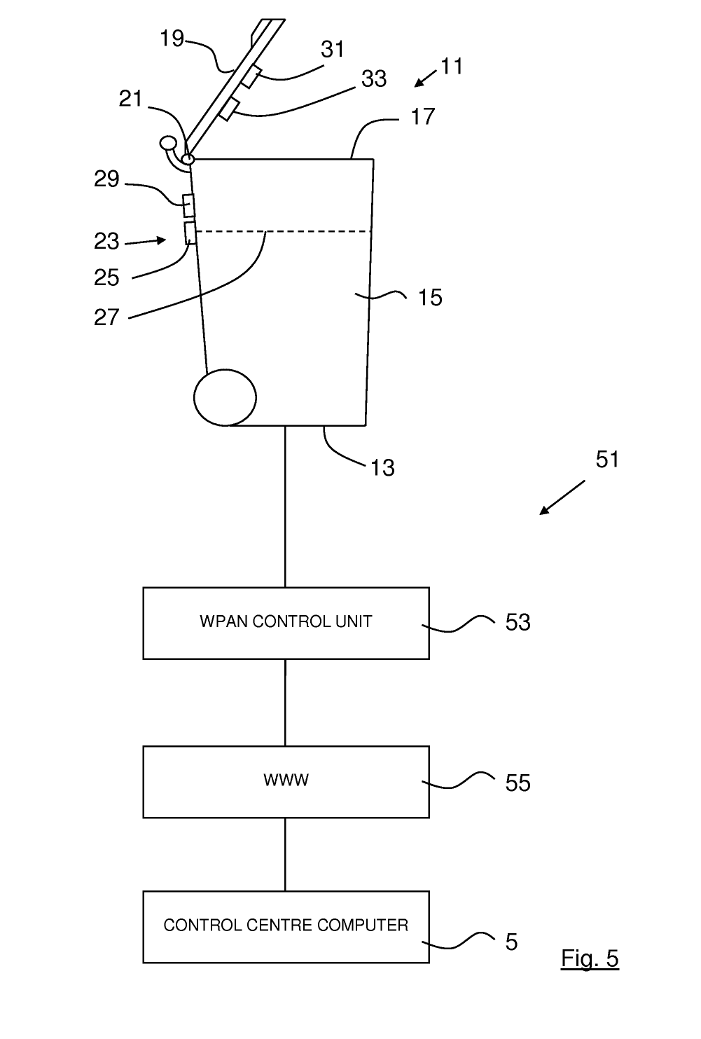

FIG. 5 is a diagrammatic representation of another embodiment of system in which the method according to the invention may be implemented; and

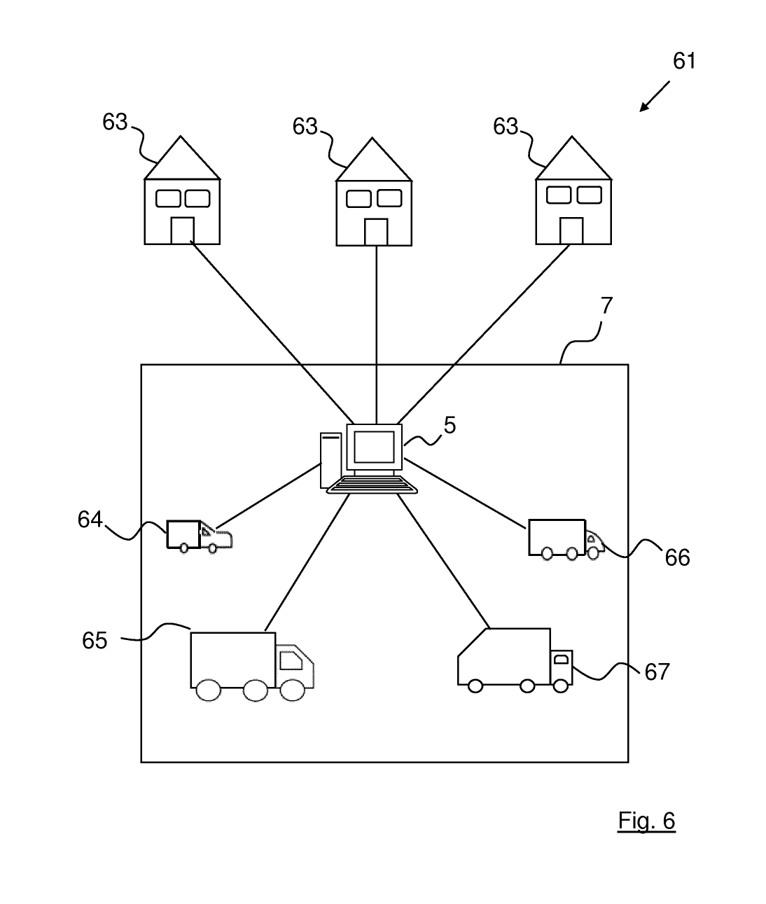

FIG. 6 is a diagrammatic representation of a system in which an alternative embodiment of the method according to the invention may be performed.

Referring to FIG. 1, there is shown a refuse collection system, indicated generally by the reference numeral 1 comprising a plurality of refuse bins 3, each of which is associated with a particular household (not shown), and a control centre computer 5 operated by a refuse disposal operator 7. The refuse disposal operator 7 has a plurality of collection vehicles 9(a), 9(b), 9(c) and 9(d) at their disposal.

The refuse bins 3 each comprise an RFID reader unit and a communications module (not shown), the RFID reader unit being configured to recognize refuse having an RFID tag associated therewith located in the bin and generate a data message indicative of the type and quantity of refuse in the refuse bin. The communications module is configured to receive the data message from the RFID reader unit and thereafter transmit the data message to the control centre computer 5 operated by the refuse disposal operator 7. The control centre computer 5 is configured to receive data messages transmitted by the communications modules of the refuse bins 3. The control centre computer 5 has a scheduling module (not shown) stored thereon for scheduling a refuse collection by a collection truck 9(a), 9(b), 9(c), 9(d) of a particular type of refuse from at least one of the refuse bins 3 based on the data message received from the communications module of the refuse bin 3.

In use, a customer places refuse with an RFID tag associated therewith into the refuse bin 3 and the RFID reader in the refuse bin will identify the RFID tag. The RFID tag will provide an indication of the type of refuse that has been placed in the bin. The RFID reader will be able to identify many RFID tags that are located in the refuse bin and will be able to generate a data message detailing what type of refuse and how much of each type of refuse there is stored in the refuse bin. This data message is transmitted from the refuse bin's communications module to the control centre computer 5 of the refuse disposal operator 7. On receipt of a plurality of data messages, the control centre computer will collate the messages together and determine how much refuse there is that requires collection, what type of refuse requires collection, and where the refuse of the particular types is located. The refuse disposal operator can thereafter send refuse collection vehicles to the location of one or more refuse bins to make collections of one or more different types of refuse from the refuse bins 3.

The control centre computer may send the information to the refuse collection trucks 9 in electronic format in the manner of an itinerary for the refuse collection vehicle. This itinerary may include the address or GPS co-ordinates of the dwellings that own the refuse bins for collection and/or a route planner for the refuse collection truck to follow. Alternatively, a paper based itinerary could be provided to the operators of the refuse collection truck that they can follow. The refuse collection trucks may then travel around to the location of the refuse bins on their itinerary and collect the particular type of refuse from each refuse bin on their itinerary. In some cases, where the refuse truck has several distinct compartments, the refuse truck will have the ability to collect more than one type of refuse and the itinerary may include multiple types of refuse to be collected from the bins 3. The control centre computer will have a scheduling module to determine what refuse needs to be collected, what the most efficient routes will be for the refuse collection vehicles, the refuse bins that must be visited by the various collection vehicles and other like tasks.

In addition to the above, each of the collection trucks 9(a)-9(d) is provided with a location tracking device so that the collection truck can be sent a collection itinerary of refuse bins in its immediate vicinity and/or on its route back to the depot while the collection vehicle 9(a)-9(d) is already out in the field amongst the households. Furthermore, in the embodiment shown, one of the refuse collection trucks, 9(d), is provided by a third party logistics operator rather than being a collection vehicle provided by the refuse disposal operator. The collection vehicle 9(d) can be used due in part to the fact that the refuse is particularly clean refuse and indeed the collection vehicle 9(d) can be used to pick up certain suitable types of clean refuse. This will allow the third party logistics provider to make use of their backhaul capacity and will further spread the collection burden for the refuse disposal operator.

Referring to FIG. 2 of the drawings, there is shown a more detailed view of the refuse bin for use in the method and system according to the present invention. The refuse bin, indicated generally by the reference numeral 11, comprising a base 13, a side wall 15 extending upwardly from the base defining a charging and a discharge mouth 17, and a closure, in this case a lid 19 pivotally mounted about hinge 21, which in turn is mounted on the side wall, and moveable to and from a position free of the mouth (as shown) and a position closing the mouth.

The refuse bin 11 comprises an RFID reader 23 which in turn comprises a reader unit 25 and a detection coil 27 shown in dashed outline, which extends circumferentially about the refuse bin side wall 15. The refuse bin 11 further comprises a communications module 29 configured to receive data from the RFID reader 23 relating to one or more RFID tags in the refuse bin and transmit a data message containing data relating to the one or more RFID tags in the refuse bin to the control centre computer (not shown). There is shown a plurality of pods 28, each having an RFID tag 30 associated therewith, placed in the refuse bin 11.

There is further shown a proximity sensor 31 and an olfactory sensor 33 mounted on the underside of the lid 19, both of which are in communication with the communications module 29. The proximity sensor 31 is an infra-red sensor that can detect proximity of refuse in the refuse bin. As the refuse bin is filled and the refuse is stacked up adjacent to the mouth, the proximity sensor will detect the refuse and will send a signal to the communications module which in turn will send a data message to a remote location indicative that the refuse bin needs to be emptied imminently. The olfactory sensor 33 can detect odours from rotting foodstuffs and the like materials that should not be in the refuse bin. On detecting a foreign object in the refuse bin, the olfactory sensor can transmit a signal to the communication unit which can generate a data message and transmit the data message to a remote location. This can be used in due course to warn, inform or fine the inhabitant of the dwelling to which the refuse bin belongs.

Referring to FIG. 3, there is shown a plan view of an alternative embodiment of refuse bin according to the invention, indicated generally by the reference numeral 34 and where like parts have been given the same reference numeral as before. The refuse bin is segmented into a plurality of compartments of varying sizes by dividing walls 35. The individual compartments can be coded, such as by colour coding, for reception of different types of refuse. By compartmentalizing the refuse bin 34, removal of individual items or items of a particular type will be facilitated.

Referring to FIG. 4, there is shown a diagrammatic representation of a system in which the refuse bin according to the invention is used, indicated generally by the numeral 41. The system comprises a GSM network 43 and a control centre computer 5 of a refuse disposal operator. In this embodiment, the communications module 29 of the refuse bin 11 comprises an SMS transmitter for generating and transmitting the data message over the GSM network 43 to the remote location, in this case the control centre computer 5 of the refuse disposal operator.

Referring to FIG. 5, there is shown an alternative configuration of system according to the present invention, indicated generally by the reference numeral 51. The system 51 comprises a wireless personal area network (WPAN), in this instance a ZigBee network WPAN which in turn comprises a WPAN control unit 53. The WPAN control unit 53 may be provided by a PC, laptop or other computing device that has access to the World Wide Web (WWW) (or internet) 55. The system 51 also comprises a control centre computer 5 of a refuse disposal operator. In this embodiment, the communications module 29 of the refuse bin comprises a wireless node of the WPAN which communicates with the WPAN control unit 53. It will be understood that there may be provided other wireless nodes (not shown) in the WPAN and the communication module 29 wireless node may communicate with the WPAN control unit 53 either directly or indirectly through other nodes of the WPAN. The data message is sent from the communications module 29 to the WPAN control unit 53 and then onwards to the control centre computer 5 of the refuse disposal operator over the World Wide Web 55 or internet.

In use, an owner of the refuse bin 11 will pack their refuse into a pod 28, which is a suitably dimensioned package with an RFID tag 30, or will affix an RFID tag with an adhesive backing directly onto the refuse. The RFID tag will be programmed with a code that is indicative of the refuse type. For example, glass items will have one type of code, paper items will have another type of code, plastic items will have a third type of code and so on for all the different materials that may be placed in the refuse bin. The practice of programming the RFID tags with a given code is well known in the art and it is not deemed necessary to further elaborate this practice in this specification. It is envisaged that the owner of the refuse bin may be provided with a device for programming the RFID tag themselves and a plurality of effectively “blank” RFID tags awaiting a programmed code. The owner of the refuse bin may program the RFID tag with an appropriate code before placing the refuse into the pod bearing the RFID tag or before affixing the RFID tag to the refuse.

Once the refuse has been placed in the pod 28 or once the refuse has had a programmed RFID tag 30 attached thereto, the refuse (not shown) is placed into the refuse bin 11. The RFID reader 23 will detect the presence of the RFID tag (not shown) in the refuse bin and will register this fact with the communication module 29. It will be understood that this will be achieved in the following manner: the detection coil 27 will induce a current in the passive RFID device 30 and this current will cause the passive RFID device 30 to transmit a signal indicative of that RFID device and more specifically its RFID code. That signal will be received by the reader unit 25. The reader unit 25 of the RFID reader 23 will then pass this code onwards to the communication module 29. The communications module 29 will collate all of the information received from the reader unit into a data message to be transmitted onwards to a remote location, in this case a control centre computer 5 of the refuse disposal operator 7. The data message will contain, most importantly, information regarding exactly what type of refuse is in the refuse bin and also how much refuse is in the refuse bin. Additionally, the proximity sensor 31 and the olfactory sensor 33 may transmit data to the communications module 29 and this data will in turn be passed on to the remote location. In this way, the collection of the refuse can be organized in a more structured format and/or the subsequent sorting of the refuse will be significantly easier than was heretofore the case.

Various modifications to the systems shown above can be made without departing from the spirit of the invention. As discussed previously, the data message can be transmitted either directly to the control centre computer of the refuse disposal operator via SMS (as per the system shown in FIG. 4) or can be routed indirectly through a WPAN and then over the World Wide Web/internet (as per the system shown in FIG. 5) to the control centre computer of the refuse disposal operator. However, other means of communication, such as but not limited to, radio communications could be used to transfer the data message.

In addition to having an RFID reader in the bin itself, it is envisaged that a collection message could be provided in other ways to the refuse collection operator. For example, an SMS message could be sent directly from a customer's mobile telephone or indeed a customer's mobile telephone could be used to scan in and then transmit a code, such as a bar code or QR code, indicative of the type of refuse awaiting collection. The refuse collection operator would preferably have a database of customer telephone numbers and addresses so that when a message is received from a particular number that there is a good for collection, this number can be correlated to a particular address in the database indicating where the goods can be collected. Alternatively, a mobile phone application (commonly referred to as an “App”) could be used to alert the refuse collection operator that there is a good for collection or indeed a web interface may be provided to alert the refuse collection operator that there is refuse or one or more goods for collection at a given location. Similarly, a mobile phone or other communication device equipped for near field communications (NFC) could be used to detect RFID tags or the like on goods or refuse for collection.

Importantly, the present invention also provides a mechanism whereby goods that are not refuse per se, for example items for donation to charity, items to be returned to a third party for repair or indeed items for sale, return or simple delivery to third parties can be stored in the refuse bin and these items can be collected and delivered to the intended recipient through the present system and in accordance with the present methods. It is envisaged that these items can be treated in much the same way as items of refuse in that an RFID tag can be associated with the item and the item can be placed in the bin. Either the RFID reader and the communications module in the bin can combine to transmit a data message to the refuse disposal operator or the individual placing the item in the bin can transmit a data message directly to the refuse disposal operator through different channels. The good will be scheduled for collection in much the same way that an item of refuse will be scheduled for collection. A third party operator's collection vehicle can be alerted to the location of the item for collection and the third party operator can collect the item from the location and deliver the item to the desired destination.

Referring now to FIG. 6 of the drawings, there is shown a system in which an alternative method according to the present invention may be performed, indicated generally by the reference numeral 61 and where like parts have been given the same reference numeral as before. The system comprises a plurality of households 63 and a plurality of collection vehicles 64, 65, 66, 67 operated by a plurality of third party logistics operators. The vehicles 64, 65, 66, 67 are of a variety of types and sizes, including a van 64, truck 66, heavy goods vehicle (HGV) 65 and a refuse disposal lorry 67. It is envisaged that a wide range of vehicles could be used and the above list is not intended to be limiting.

The households 63 are shown without bins with RFID readers and communication modules. Bins with RFID readers may optionally be provided. However, in the embodiment shown in which the method is performed, it is not necessary to provide bins with RFID readers. Instead, according to the method, the householders may inform the control centre computer 5 that there is a good or refuse for collection at the household 63 in an alternative manner. For example, the householders may arrange a collection of a good or refuse by transmitting an SMS, MMS or like message (hereinafter referred to simply as an SMS for convenience) from their mobile telephone to a dedicated number. The control centre computer will have the address details associated with the mobile telephone from which the SMS was received and a collection can be arranged. Furthermore, the SMS may contain a code or indeed the number to which the SMS is transmitted will be indicative of the type of refuse or good that is to be collected.

As an alternative to using an SMS message, the mobile telephone or a dedicated communication device may be equipped with a bar code, a QR code or like code scanner in which case a code which is associated with the good or the refuse can be scanned and the scanned code will be sent to the control centre computer. As a second alternative, the mobile telephone or other dedicated communication device could be provided with a NFC scanner that is able to detect an RFID or like tag in its immediate vicinity and the device can be used to scan for RFID or like codes and thereafter transmit those codes to the control centre computer. As a third alternative, information regarding the refuse or good to be collected could be inserted into an App and the information could be relayed to the control centre computer. As a fourth alternative, the information regarding the refuse or good to be collected could be inserted into a website and the information could be relayed to the control centre computer in that manner. It will be understood that any or all of these methods, as well as the bin with the RFID reader, could be used to relay information concerning a good or refuse that is to be collected for delivery to a third party.

In the system 61 shown, the control centre computer will preferably comprise a cloud based application that includes a database of all the households and the contact details of the individuals in the households, a scheduling component that will optimize a collection and delivery itinerary, and a communication module for receiving goods and refuse collection requests and also information from collection vehicles operated by third party logistics operators. In use, the control centre computer will receive a good or refuse collection request from an individual in a household 63 through one of the methods described above and the control centre computer will collate the good or refuse collection request with good or refuse collection requests received from other individuals in other households 63. The control centre computer will determine which of the collection vehicles is most suited to carry out the collection according to the specification of the vehicle, the type of goods or refuse to be transported and the available time for the vehicle to carry out the collection and subsequent delivery. The control centre computer will thereafter send a collection itinerary to the collection vehicle with the addresses of a plurality of different households where goods or refuse must be collected and if desired, the delivery address(es) for the goods/refuse. The collection itinerary will also preferably contain a map with each of the collection locations indicated thereon. It can be seen from the foregoing that the waste and goods of a certain type can be collected from multiple locations sequentially and then delivered to one or more desired destinations in a very efficient manner.

Of particular interest is the ability of the present invention to avail of the backhaul capacity of third party logistics providers such as, for example, An Post, the national postal service in Ireland, or Royal Mail, the national postal service in the United Kingdom. Other third party logistics operators such as DHL (Registered Trade Mark,®), UPS®, FedEx® and the like could also participate in the method according to the invention to use some of their backhaul capacity. These third party logistics providers often have spare backhaul capacity however now they can use their facilities to collect goods or clean refuse from households. Furthermore, other third parties, not necessarily third party logistics operators could also be incorporated into the system and methods. For example, charities could be alerted of clothes pods or parcels that have been donated to them and the charities could be provided with information concerning the address of the household where the items are ready for collection.

For example, a mobile worker, such as a postal or courier van driver, is in a neighbourhood and his or her location is detected by use of location based software on that worker's smartphone device or another tracking device located in their van. The system is capable of detecting the presence of domestic or commercial collectible items within a given radius from the van driver's current position. These items will have been previously registered by the domestic or commercial key holder. These collectible items can comprise several categories such as waste material, mail or parcels for collection, charity donations, warranty repairs, retail items for sale or end-of-life material such as electrical goods. The van driver's smartphone device is then updated, in real-time, with a schedule of items to collect and a map based sequential routing of which premises to visit for the purposes of collection.

The registering of refuse or a good for collection can be done in a number of disparate ways. Each POD 28 with refuse or a non-refuse item therein, can be registered into a software customer relationship management (CRM) type cloud-based application for collection by a variety of means, for example by way of an SMS to a dedicated number, by way of a Bar-code, QR code or like code scan via a smartphone, by way of an NFC scan by a mobile telephone or dedicated device, by way of a smartphone App or online through a web interface. Once registered, data about the PODs 28 will then be stored in a cloud based CRM application which in turn will feed a geolocated mapping application that can provide the drivers of third party logistics operator's vans with on-demand, real-time data of geolocated positions of a wide variety of domestic or commercial Reverse Logistics services.

Dry, clean waste material, being just one of these collectible categories, can be collected from the householder by exploiting the so-called ‘backhaul’ capacity of the third party logistics operator whereby their vans or trucks are typically empty when they are ready to return to their depots. These materials can then be sold at the highest possible price for such commodity material on the basis that they are of the highest quality (it is accepted in the waste, recycling and reprocessing industries that domestically sorted waste material offers the highest quality of all available collection models). The third party logistics providers will also be able to collect various other household collectibles, in a highly cost effective manner when compared to the existing waste industry. This includes waste, charity donations, mail to be collected at the doorstep, items such as mobile devices for repair under warranty and ‘end-of-life’ disposal for electrical or other goods.

The pods 28 for storage of the refuse may be suitably dimensioned to receive one or more of the items in question and much will depend on the size of the items. For example, it is envisaged that a pod for batteries will be able to hold several batteries whereas a pod for large plastic containers will often only contain one container. It is envisaged that the pods may be relatively rigid containers constructed from cardboard or plastics however the pods may also be flexible pouches. Preferably, the pods will be constructed from a recyclable material. It is envisaged that in due course the pods will be the original packaging of the refuse material that can be stored until the refuse material has been used and then the packaging can be reused as a pod.

In the embodiment shown in FIG. 2, the detection coil 27 is positioned on the internal wall of the refuse bin but could be mounted on the external wall of the refuse bin or indeed may be integral with the side wall 15 and moulded inside the plastic structure of the side wall itself. It is envisaged that in addition to the above components, an alarm unit (not shown) may be provided on the refuse bin that will provide an indicator to the owner of the refuse bin that there is a foreign substance such as rotting food in the refuse bin and that they are likely to be fined or adversely affected in some way as a result of the presence of the foreign substance in the refuse bin or are simply in contravention of best practices. Furthermore, various power supplies could be provided to operate the components of the refuse bin however it is envisaged that a solar panel on the bin itself would be particularly suitable for providing the power supply to the components.

In the embodiments shown, the refuse bin 11 has been illustrated using a so-called “wheelie bin”. It will be understood that other constructions and configurations of refuse bin 3 could be provided and indeed these other constructions may be more suited to facilitating targeted collections of refuse materials from the refuse bin. For example, the refuse bin 11 could have a construction similar to a filing cabinet comprising an upright structure having, if desired, a closure provided by a door hingedly or otherwise mounted on one side of the structure and a plurality of shelves and/or compartments in the cabinet. This would facilitate targeted collections of certain waste materials from the refuse bin if desired and may also allow for improved segregation of materials for collection.

In an alternative embodiment of the invention, it may not be necessary for a household to have a dedicated refuse bin with storage capability. Instead, there may be provided a monitoring unit with a communications module and an RFID reader in the household. The RFID reader will be able to detect the presence of goods or refuse stored in pods in the household that are brought into proximity of the unit and the communications module will communicate the presence of the goods or refuse that is ready for collection to the control centre computer. The control centre computer can thereafter schedule the collection in the normal manner. Throughout the specification, reference is made to the collection of refuse from households. As mentioned above, the present invention also relates to the collection of commercial and industrial goods and waste and therefore the term household will also be deemed to include commercial and industrial premises.

It is envisaged that the control centre computer of the refuse disposal operator may be operated on behalf of the operator per se and they may not have direct control over the control centre computer. However, this is for the purposes of this specification still considered a control centre computer of the refuse disposal operator and operated thereby. Furthermore, the control centre computer may be in the same or a different jurisdiction to the refuse bins and the refuse disposal operator and the appended claims are also intended to include implementations where the control centre computer or the refuse bins are located in different jurisdictions.

It is envisaged that various other modifications could be made to the system and methods described in the application in suit without departing from the spirit or scope of the present invention. For example, the olfactory sensor, if provided, could be a standalone device. Rather than having an olfactory sensor on each bin, the olfactory sensor could be associated with the refuse collection vehicle and could be used to scan the contents of the refuse bin during collection. Furthermore, additional components could be added to the system and the bin in particular to improve collection and or monitoring. For example, it is envisaged that one or more weighing scales may be incorporated into the bin to indicate the weight of one or more items of refuse in the bin. Similarly, a GPS tracking device may be associated with the bin to facilitate collections and correct billing practices.

In addition to the above, it is envisaged that the method according to the invention may include periodic communications with the owners of the refuse bins to disseminate information related to, but not limited to, collection schedules. The information could for example relate to pricing programs or incentive schemes to promote the owners of the bins to provide certain types of refuse in the bin from time to time.

In this specification the terms “comprise, comprises, comprised and comprising” and the terms “include, includes, included and including” are all deemed totally interchangeable and should be afforded the widest possible interpretation.

The invention is in no way limited to the embodiment hereinbefore described but may be varied in both construction and detail within the scope of the claims.

1. A refuse collection system for a plurality of households, each household having its own dedicated refuse bin located at that household, the refuse collection system comprising the plurality of refuse bins located at the households, a control centre computer operated by a refuse disposal operator in communication with each of the bins in each of the households, and a plurality of collection vehicles also in communication with the control centre computer, in which:
the refuse bins in each of the households each comprise:
an RFID reader unit and a communications module; the RFID reader unit being configured to recognize refuse having an RFID tag associated therewith located in the bin and generate a data message indicative of the type and quantity of refuse in the refuse bin; the communications module being configured to receive the data message from the RFID reader unit and thereafter transmit the data message to the control centre computer operated by the refuse disposal operator;
the collection vehicles each having:
a GPS tracking unit associated therewith and a communications module for communications with the control centre computer, the collection vehicles each being configured to periodically transmit their location data to the control centre computer;
the control centre computer having:
a communications module configured to receive data messages transmitted by the communications modules in each of the refuse bins; the control centre computer having a scheduling module stored thereon for scheduling a refuse collection of a particular type of refuse from at least one of the refuse bins in it least one of the households based on the data message received from the communications module of the refuse bin, the scheduling module being configured to generate a collection itinerary for a collection vehicle based on the location data received from the collection vehicle and the data messages received from the refuse bins, the control centre computer being configured to transmit the collection itinerary to the collection vehicle.

2. A refuse collection system as claimed in claim 1 in which the interior of one or more of the refuse bins is divided into a plurality of compartments, each for reception of refuse having an RFID tag associated therewith.

3. A refuse collection system as claimed in claim 1 in which the interior of one or more of the refuse bins is divided into a plurality of compartments, one of which is for reception of a non-refuse good having an RFID tag associated therewith.

4. A refuse collection system as claimed in claim 1 in which the control centre computer is provided with means to receive a goods collection request from a household resident through an alternative communications channel other than through a data message sent by one of the refuse bins, and in which the scheduling module is configured to generate a collection itinerary for a collection vehicle based on the location data received from the collection vehicle and the goods collection request received from the household resident through the alternative communications channel, the control centre computer being configured to transmit the collection itinerary to the collection vehicle.

5. A refuse collection system as claimed in claim 1 in which the refuse bin's communications module comprises a short messaging service (SMS) module for generating and transmitting the data message in an SMS message to the control centre computer.

6. A refuse collection system as claimed in claim 1 in which the refuse bin's communications module comprises a radio transmitter for transmitting the data message to the control centre computer.

7. A refuse collection system as claimed in claim 1 in which the refuse bin's communications module comprises a node of a WPAN and in which there is further provided a control unit of the WPAN located remotely from the node of the WPAN and in communication with the refuse bin's communications module for receipt of data messages from the refuse bin's communications module, the control unit of the WPAN having means to transmit the data message onwards to the control centre computer.

8. A refuse collection system as claimed in claim 1 in which each of the refuse bins is further provided with means to detect the available capacity of the refuse bin, said means being in communication with the refuse bin's communications module.

9. A refuse collection system as claimed in claim 1 in which one or more of the collection vehicles are operated by a third party logistics provider.

10. A refuse collection system as claimed in claim 1 in which instead of the household being provided with a refuse bin, the household is provided with a monitoring unit, and in which:
the monitoring unit comprises an RFID reader unit and a communications module; the RFID reader unit being configured to recognize refuse having an RFID tag associated therewith brought into proximity with the monitoring unit and generate a data message indicative of the type and quantity of refuse that has been brought into proximity with the monitoring unit; the communications module being configured to receive the data message from the RFID reader unit and thereafter transmit the data message to the control centre computer operated by the refuse disposal operator;
the control centre computer having a communications module configured to receive data messages transmitted by the communications modules in each of the monitoring units; the control centre computer having a scheduling module stored thereon for scheduling a refuse collection of a particular type of refuse from at least one of the households based on the data message received from the communications module of the monitoring unit, the scheduling module being configured to generate a collection itinerary for a collection vehicle based on the location data received from the collection vehicle and the data messages received from the monitoring units, the control centre computer being configured to transmit the collection itinerary to the collection vehicle.

11. A method of scheduling the collection of refuse by a refuse disposal operator from a plurality of households, each household having its own dedicated refuse bin located at that household, in a refuse collection system comprising the plurality of refuse bins located at the households, a control centre computer operated by the refuse disposal operator in communication with each of the bins in each of the households, and a plurality of collection vehicles also in communication with the control centre computer, the refuse bins in each of the households each comprise an RFID reader unit and a communications module; the collection vehicles each having a GPS tracking unit associated therewith and a communications module for communications with the control centre computer; the control centre computer having a communications module configured to receive data messages transmitted by the communications modules in each of the refuse bins and the control centre computer having a scheduling module stored thereon, the method comprising the steps of:
in each of the refuse bins, the RFID reader unit detecting refuse having an RFID tag associated therewith located in the refuse bin and generating a data message indicative of the type and quantity of refuse in the refuse bin; the refuse bins communication module receiving the data message from the bin's RFID reader unit and thereafter transmitting the data message to the control centre computer operated by the refuse disposal operator; and
the collection vehicles each periodically transmitting their location data to the control centre computer; and
the control centre computer receiving the plurality of data messages from the refuse bins, the control centre computer collating the data messages and determining the types of refuse available for collection and the amount of each type of refuse available for collection, the control centre computer's scheduling module scheduling a refuse collection of a particular type of refuse from at least one of the refuse bins in it least one of the households based on the collated data messages received from the communications modules of the refuse bins; the scheduling module generating a collection itinerary for a collection vehicle based on the location data received from the collection vehicle and the collated data messages received from the refuse bins; and the control centre computer transmitting the collection itinerary to the collection vehicle.

12. A method as claimed in claim 11 in which the method comprises the additional steps of: the control centre computer receiving a non-refuse goods collection request; the scheduling module generating a collection itinerary for a collection vehicle based on the location data received from the collection vehicle and the non-refuse goods collection request; and the control centre computer transmitting the collection itinerary to the collection vehicle.

13. A method as claimed in claim 12 in which the control centre computer receives the non-refuse goods collection request through an alternative communications channel other than through a data message sent by one of the refuse bins.

14. A method as claimed in claim 11 in which having scheduled the collection of one of refuse and a good, a message is transmitted by the control centre computer to the owner of the refuse bin from which a collection will be made indicating that a collection is imminent.

15. A method as claimed in claim 11 in which the step of transmitting a collection itinerary to the collection vehicle further comprises transmitting the collection itinerary to a collection vehicle operated by a third party logistics provider.

16. A method for the disposal and collection of refuse from a plurality of households, each household having its own dedicated refuse bin located at that household, in a refuse collection system comprising the plurality of refuse bins located at the households, a control centre computer operated by a refuse disposal operator, and a plurality of collection vehicles, the refuse bins in each of the households each comprise an RFID reader unit and a communications module for transmitting data messages to the control centre computer; the collection vehicles each having a GPS tracking unit associated therewith and a communications module for communications with the control centre computer; the control centre computer having a communications module configured to communicate with the collection vehicles and to receive data messages transmitted by the communications modules in each of the refuse bins and the control centre computer having a scheduling module stored thereon, the method comprising the steps of:
the residents associating an RFID tag with an item of refuse prior to placing the refuse in the refuse bin, the RFID tag having a code indicative of the type of refuse to which it is being associated;
the refuse bin RFID reader reading the RFID tag associated with an item of refuse in the bin and generating a data message detailing the contents of the refuse bin;
the RFID reader passing the data message to the communications module of the refuse bin and the communications module transmitting the data message onwards to the control centre computer;
the control centre computer receiving a plurality of data messages from the plurality of refuse bins;
the control centre computer collating the data messages and determining the types of refuse available for collection and the amount of each type of refuse available for collection;
the control centre computer receiving location data from each of the collection vehicles; and
the control centre computer scheduling module generating a collection itinerary for a collection vehicle based on the location data received from the collection vehicle and the collated data messages received from the refuse bins;
the control centre computer transmitting the collection itinerary to the collection vehicle; and
the collection vehicles collecting the refuse from the refuse bins.

17. A method as claimed in claim 16 in which the step of scheduling the collection of a particular type of refuse comprises the steps of: providing a refuse collection vehicle to collect that particular type of refuse; providing a collection itinerary to the refuse collection vehicle specifying the location of each of the refuse bins from which it is due to collect; and the refuse collection vehicle travelling to the locations of the refuse bins and collecting the specified type of refuse from the refuse bins.

18. A method as claimed in claim 16 in which the refuse collection vehicle delivers the collected refuse to a specified recycling centre that is dedicated to recycling that particular type of refuse.

19. A method as claimed in claim 16 in which the control centre computer schedules collection of two or more disparate types of refuse from a plurality of the refuse bins based on the collated data.

20. A method as claimed in claim 16 in which the step of the residents associating an RFID tag with an item of refuse prior to placing the refuse in the refuse bin further comprises the residents placing the refuse in a pod having the RFID tag.

21. A method as claimed in claim 16 in which the step of the residents associating an RFID tag with an item of refuse prior to placing the refuse in the refuse bin further comprises the residents applying the RFID tag directly to the refuse.

22. A method as claimed in claim 16 in which the method comprises the initial step of the residents programming the RFID tag with the code indicative of the type of refuse to which it is being associated.

23. A method as claimed in claim 16 comprising the additional steps of: the refuse bin further comprising a means to detect the available capacity of the refuse bin, said means being in communication with the communications module; the means to detect the available capacity of the refuse bin passing a data message indicating the available capacity in the refuse bin to the communications module and the communications module transmitting the data message onwards to the control centre computer; and the control centre computer scheduling the collection of a refuse bin based on the available capacity in the refuse bin.

24. A method as claimed in claim 16 in which the refuse bin is provided with a plurality of compartments each of which is dedicated to a particular type of refuse and in which the step of the resident placing the refuse in the refuse bin further comprises the resident placing the refuse in an appropriate compartment of the refuse bin.

25. A method as claimed in claim 16 in which the method comprises the additional steps of: a resident associating the RFID tag with a non-refuse good item prior to placing the item in the refuse bin; transmitting a non-refuse good collection request to the control centre computer; the control centre computer receiving a non-refuse goods collection request; the scheduling module generating a collection itinerary for a collection vehicle based on the location data received from the collection vehicle and the non-refuse goods collection request; and the control centre computer transmitting the collection itinerary for the non-refuse good to the collection vehicle.

26. A method as claimed in claim 25 in which the control centre computer receives the non-refuse goods collection request through an alternative communications channel other than through a data message sent by one of the refuse bins.

27. A method as claimed in claim 16 in which the step of transmitting the collection itinerary comprises transmitting the collection itinerary to a third party logistics provider.

28. A method of scheduling the collection of one or more goods from a plurality of households and thereafter distributing the goods to one or more recipients, in a system comprising a control centre computer having a scheduling module and a control centre computer communications module, a plurality of households each having a communications module associated therewith for communication with the control centre computer communications module, and a plurality of collection vehicles operated by a plurality of third party logistics operators, each collection vehicle having a GPS tracking unit and a collection vehicle communications module for communication with the control centre computer communications module, the method comprising the steps of:
an individual associated with a particular household using the communications module to transmit a good collection request to the control centre computer;
the control centre computer collating that good collection request with good collection requests for the same type of goods received from a plurality of other individuals associated with other households;
the control centre computer's scheduling module generating a collection itinerary for one of the collection vehicles based on location data received from the collection vehicle and the plurality of good collection requests;
the control centre computer transmitting the collection itinerary to one of the collection vehicles; and
the collection vehicle thereafter following the collection itinerary and collecting the good from the household and delivering the good to a desired recipient.

29. A method as claimed in claim 28 comprising the additional step of the individual packaging the good in a dedicated pod with an identifier of the goods associated therewith prior to the goods collection.

30. A method as claimed in claim 28 comprising the initial step of the individual registering their household with the control centre computer by providing at least their address and their contact details to the control centre computer.

31. A method as claimed in claim 28 in which the step of transmitting the collection itinerary to one of the collection vehicles comprises transmitting the collection itinerary to one of the collection vehicles in response to a collection itinerary request issued by the collection vehicle.

32. A method as claimed in claim 31 in which the collection itinerary request includes the time duration that the collection vehicle is available to collect and distribute goods and the collection itinerary is compiled taking into account the available time duration.

33. A method as claimed in claim 28 in which the household is provided with a monitoring unit having an RFID reader and the communications module, and in which the step of the individual transmitting a good collection request to the control centre computer further comprises the steps of: the individual bringing an item for collection with an RFID tag associated therewith into proximity with the monitoring unit; the monitoring unit's RFID reader detecting the RFID tag and generating a good collection request; and the monitoring unit's communications module transmitting the good collection request to the control centre computer.
